(19) United States
(12) Patent Application Publication
(10) Pub. No.: US 2017/0221407 A1
(43) Pub. Date: Aug. 3, 2017

(54) FIELD-SEQUENTIAL IMAGE DISPLAY DEVICE AND IMAGE DISPLAY METHOD

(71) Applicant: Sharp Kabushiki Kaisha, Osaka-shi, Osaka (JP)

(72) Inventor: Masamitsu KOBAYASHI, Osaka-shi (JP)

(73) Assignee: Sharp Kabushiki Kaisha, Osaka-shi, Osaka (JP)

(21) Appl. No.: 15/107,148

(22) PCT Filed: Nov. 4, 2014
(86) PCT No.: PCT/JP2014/079165

§ 371 Date: Jun. 22, 2016

(30) Foreign Application Priority Data
Feb. 26, 2014 (JP) 2014-035016

(51) Int. Cl. G09G 3/20; G09G 3/36; G06F 3/01; G09G 3/34

(52) U.S. Cl. CPC G09G 3/2022; G09G 3/3406; G09G 3/36; G06F 3/013; G09G 2310/0235; G09G 2320/0626; G09G 2320/0247; G09G 2354/00; G09G 2320/0295

(57) ABSTRACT

A subframe data generation unit 12 selects pixels sequentially and performs the following processing on the selected pixel P. The minimum value of brightness Dr, Dg, Db of three colors is defined as distributed brightness Ds, and a distribution ratio α is set to a value of 1 at which color breakup is the smallest. An evaluation value Qi related to a color difference when aline of sight moves is calculated based on brightness of the selected pixel P and brightness of neighboring pixels Pi (i=1 to N), and the distribution ratio α is decreased in steps until the maximum value Qmax of the evaluation value Qi is less than or equal to a threshold value Qth. The brightness Dr, Dg, Db of three colors is converted to brightness Ew, Er, Eg, Eb of four colors using the distribution ratio α determined for each pixel. This suppresses irregular flicker that occurs in the vicinity a boundary of pixels.

### TECHNICAL FIELD

The present invention relates to an image display device, and more specifically relates to a field-sequential image display device and a field-sequential image display method.

### BACKGROUND ART

There has been known a field-sequential image display device for displaying a plurality of subframes in one frame period. For example, a typical field-sequential image display device is provided with a backlight including red, green, and blue light sources, and displays red, green, and blue subframes in one frame period. When the red subframe is to be displayed, a display panel is driven based on red video data, and the red light source emits light. Subsequently, the green subframe and the blue subframe are displayed in a similar manner. The three subframes displayed in a time-division manner are synthesized on retinas of an observer by an afterimage phenomenon, and recognized as one color image by the observer.

In the field-sequential image display device, when a line of sight of the observer moves within a display screen, the observer may see the colors of the respective subframes separate from each other (this phenomenon is called color breakup). As a method for suppressing the color breakup, there is known a method of displaying at least one color component of red, green and blue in two or more subframes in one frame period. For example, in a field-sequential image display device for displaying white, red, green, and blue subframes in one frame period, the red color component is displayed in the red and white subframes, the green color component is displayed in the green and white subframes, and the blue color component is displayed in the blue and white subframes.

In relation to the present invention, the following techniques have been known. Patent Document 1 describes that in a field-sequential image display device for displaying white, red, green, and blue subframes in one frame period, a display gradation level which is lower than the lowest value of the display gradation levels of red, green, and blue pixel data is defined as white pixel data, and the white pixel data is subtracted from the red, green, and blue pixel data.

Patent Document 2 describes that in a field-sequential display device for displaying at least each one of an in-between color subfield that displays in-between color video and a three primary color subfield that displays red, green, or blue video in one frame period, the in-between color video is displayed both in the in-between color subfield and the three primary color subfield. Paragraph 0037 describes that a ratio used for distributing the in-between color video into two subfields is determined in accordance with which of color breakup or color rainbow is to be reduced more.

Patent Document 3 describes that in a field-sequential liquid crystal display device for displaying white, red, green, and blue subframes in one frame period, gradation of white is determined from gradation of red, green, and blue, brightness of four colors is calculated from the gradation of four colors, the brightness of red, green, and blue is determined based on the brightness of white, and the gradation of red, green, and blue is calculated from the brightness of red, green, and blue.

### PRIOR ART DOCUMENTS

### Patent Documents

[Patent Document 1] Japanese Laid-Open Patent Publication No. 2002-318564

[Patent Document 2] Japanese Laid-Open Patent Publication No. 2003-241714

[Patent Document 3] Japanese Laid-Open Patent Publication No. 2006-293095

### SUMMARY OF THE INVENTION

### Problems to be Solved by the Invention

In the field-sequential image display device, when adjacent pixels display different colors, irregular flicker may occur on the boundary of the pixels. Hereinafter, an image display device, which displays white, red, green, and blue subframes in one frame period and defines the minimum value of gradation of red, green, and blue as gradation of white for each pixel, is referred to as a “conventional image display device.”

As shown in FIG. 20, there is considered a case where a pixel Pa that displays white and a pixel Pb that displays green are adjacent to each other. FIG. 21 is a diagram showing brightness of each subframe of the pixels Pa, Pb in the conventional image display device. The brightness of the pixel Pa is the maximum value Wmax in the white subframe, and is zero in the red, green, and blue subframes. The brightness of the pixel Pb is the maximum value Gmax in the green subframe, and is zero in the white, red, and blue subframes.

Arrows V1 to V3 shown in FIG. 21 represent directions of lines of sight of the observer. When the line of sight of the observer is fixed to the V1 direction, the pixel Pa looks white and the pixel Pb looks green to the observer. However, since the eyes of the observer always move irregularly (involuntary eye movement during fixation), the line of sight of the observer moves irregularly in the left direction (V2 direction) and the right direction (V3 direction). At this time, the observer observes a result of integrating the brightness of the pixels in the direction of the line of sight (hereinafter referred to as integrated brightness). As shown in FIG. 22, a difference occurs between the integrated brightness when the line of sight moves in the left direction and the integrated brightness when the line of sight moves in the right direction. For this reason, the colors of the pixels Pa, Pb look different to the observer between when the line of sight moves in the left direction and when the line of sight moves in the right direction. As a result, the observer recognizes irregular flicker that occurs in the vicinity of the boundary of the pixels Pa, Pb.

The irregular flicker also occurs on a boundary of a pixel that displays white and a pixel that displays yellow, and a boundary of a pixel that displays white and a pixel that displays cyan. In the image display devices described in Patent Documents 1 to 3, the irregular flicker that occurs in the vicinity of a boundary of pixels cannot be suppressed sufficiently.

Accordingly, it is an object of the present invention to suppress irregular flicker that occurs in the vicinity of a boundary of pixels in a field-sequential image display device.

### Means for Solving the Problems

According to a first aspect of the present invention, there is provided a field-sequential image display device including: a subframe data generation unit for generating output brightness data corresponding to a plurality of subframes based on input brightness data corresponding to a plurality of color components; and a display unit for displaying the plurality of subframes in one frame period in accordance with a video signal based on the output brightness data, wherein the subframe data generation unit generates the output brightness data with regard to each pixel based on the input brightness data by determining a distribution ratio for each pixel based on brightness of the pixel and brightness of neighboring pixels, and distributing the brightness of the pixel to the plurality of subframes in accordance with the distribution ratio.

According to a second aspect of the present invention, in the first aspect of the present invention, with regard to each pixel, the subframe data generation unit calculates an evaluation value related to a color difference when a line of sight moves, based on the brightness of the pixel and the brightness of the neighboring pixels, and determines the distribution ratio based on the evaluation value.

According to a third aspect of the present invention, in the second aspect of the present invention, with regard to each pixel and each neighboring pixel, the subframe data generation unit calculates integrated brightness when the line of sight moves and integrated brightness when the line of sight is fixed, and calculates the evaluation value based on variations in the two kinds of integrated brightness.

According to a fourth aspect of the present invention, in the third aspect of the present invention, with regard to each pixel and each neighboring pixel, the subframe data generation unit calculates, as the evaluation value, a ratio of the variation in the integrated brightness when the line of sight moves with respect to the variation in the integrated brightness when the line of sight is fixed.

According to a fifth aspect of the present invention, in the fourth aspect of the present invention, the subframe data generation unit includes a distributed brightness calculation unit for calculating distributed brightness data representing brightness to be distributed to the plurality of subframes based on the input brightness data, an integrated brightness calculation unit for calculating the two kinds of integrated brightness based on the input brightness data and the distributed brightness data, and an output brightness calculation unit for generating the output brightness data by calculating the evaluation value based on the two kinds of integrated brightness, determining the distribution ratio based on the evaluation value, and distributing the brightness of the pixel contained in the input brightness data to the plurality of subframes in accordance with the distribution ratio.

According to a sixth aspect of the present invention, in the fifth aspect of the present invention, the subframe data generation unit further includes a stimulus value calculation unit for converting the two kinds of integrated brightness to stimulus values, and the output brightness calculation unit calculates the evaluation value based on the stimulus values.

According to a seventh aspect of the present invention, in the second aspect of the present invention, with regard to each pixel, the subframe data generation unit determines the distribution ratio such that a maximum value of the evaluation values is less than or equal to a threshold.

According to an eighth aspect of the present invention, in the seventh aspect of the present invention, the subframe data generation unit determines the distribution ratio with regard to each pixel by setting the distribution ratio to the maximum value at first, and decreasing the distribution ratio in steps until the maximum value of the evaluation value is less than or equal to the threshold.

According to a ninth aspect of the present invention, in the second aspect of the present invention, with regard to each pixel and each neighboring pixel, the subframe data generation unit makes the evaluation value larger as a distance between the pixel and the neighboring pixel is smaller.

According to a tenth aspect of the present invention, in the second aspect of the present invention, with regard to each pixel and each neighboring pixel, the subframe data generation unit makes a value to be compared with the evaluation value smaller as a distance between the pixel and the neighboring pixel is smaller.

According to an eleventh aspect of the present invention, in the second aspect of the present invention, with regard to each pixel, the subframe data generation unit smooths the distribution ratio determined based on the evaluation value in a time axial direction, and distributes the brightness of the pixel to the plurality of subframes in accordance with the smoothed distribution ratio.

According to a twelfth aspect of the present invention, in the first aspect of the present invention, the subframe data generation unit has a plurality of methods for determining the distribution ratio, and switches the methods for determining the distribution ratio in units of a pixel.

According to a thirteenth aspect of the present invention, in the first aspect of the present invention, the image display device further includes: a gradation/brightness conversion unit for converting input gradation data to the input brightness data; and a brightness/gradation conversion unit for converting the output brightness data to output gradation data, wherein the video signal is based on the output gradation data.

According to a fourteenth aspect of the present invention, there is provided a field-sequential image display method including: a step of generating output brightness data corresponding to a plurality of subframes based on input brightness data corresponding to a plurality of color components; and a step of displaying the plurality of subframes in one frame period in accordance with a video signal based on the output brightness data, wherein in the step of generating, the output brightness data is generated with regard to each pixel based on the input brightness data by determining a distribution ratio for each pixel based on brightness of the pixel and brightness of neighboring pixels, and distributing the brightness of the pixel to the plurality of subframes in accordance with the distribution ratio.

### Effects of the Invention

According to the first or fourteenth aspect of the present invention, when output brightness data is to be generated, a distribution ratio is determined for each pixel based on brightness of the pixel and brightness of neighboring pixels, and the brightness of the pixel is distributed to a plurality of subframes in accordance with the determined distribution ratio, whereby it is possible to distribute the brightness of the pixel to the plurality of subframes at a suitable ratio, and thus suppress irregular flicker that occurs in the vicinity of the boundary of the pixels in the field-sequential image display device (or image display method).

According to the second aspect of the present invention, an evaluation value related to a color difference when a line of sight moves is calculated, and the distribution ratio is determined based on the calculated evaluation value, whereby it is possible to distribute the brightness of the pixel at a suitable ratio in consideration of the color difference when the line of sight moves, and thus suppress the irregular flicker.

According to the third aspect of the present invention, based on a variation in integrated brightness when the line of sight moves and a variation in integrated brightness when the line of sight is fixed, it is possible to calculate a suitable evaluation value for suppressing the irregular flicker.

According to the fourth aspect of the present invention, a ratio of the variation in the integrated brightness when the line of sight is fixed with respect to the variation in the integrated brightness when the line of sight moves is calculated, whereby it is possible to calculate a suitable evaluation value for suppressing the irregular flicker.

According to the fifth aspect of the present invention, it is possible to constitute a subframe data generation unit of the image display device capable of suppressing the irregular flicker using a distributed brightness calculation unit, an integrated brightness calculation unit, and an output brightness calculation unit.

According to the sixth aspect of the present invention, the integrated brightness is converted to a stimulus value, and the evaluation value is calculated based on the obtained stimulus value, whereby it is possible to calculate an evaluation value which fits human visual characteristics.

According to the seventh aspect of the present invention, with regard to each pixel, the distribution ratio is determined such that the maximum value of the evaluation value is less than or equal to a threshold, whereby it is possible to suppress the irregular flicker to a predetermined degree.

According to the eighth aspect of the present invention, with regard to each pixel, the distribution ratio is decreased in steps until the maximum value of the evaluation value is less than or equal to the threshold, whereby it is possible to suppress color breakup while suppressing the irregular flicker to the predetermined degree.

According to the ninth aspect of the present invention, the evaluation value is made larger for the closer neighboring pixel to have a larger effect on determination of the distribution ratio, whereby it is possible to change the distribution ratio spatially smoothly, and thus improve the image quality of a display image.

According to the tenth aspect of the present invention, the value to be compared with the evaluation value is made smaller for the closer neighboring pixel to have a larger effect on determination of the distribution ratio, whereby it is possible to change the distribution ratio spatially smoothly, and thus improve the image quality of the display image.

According to the eleventh aspect of the present invention, the distribution ratio is smoothed in a time axial direction to change the distribution ratio temporally smoothly, thus enabling improvement in image quality of the display image.

According to the twelfth aspect of the present invention, the distribution ratio determining method is switched in units of a pixel, to disperse within the display image the color breakup and the irregular flicker which cannot be suppressed only by applying one distribution ratio determining method, thus enabling improvement in image quality of the display image.

According to the thirteenth aspect of the present invention, even when input gradation data is input from the outside and the display unit has a nonlinear characteristic, it is possible to constitute an image display device capable of suppressing the irregular flicker using a gradation/brightness conversion unit and a brightness/gradation conversion unit.

### BRIEF DESCRIPTION OF THE DRAWINGS

FIG. 1 is a block diagram showing a configuration of an image display device according to a first embodiment of the present invention.

FIG. 2 is a block diagram showing a configuration of a display unit shown in FIG. 1.

FIG. 3 is a block diagram showing a detailed configuration of a subframe data generation unit shown in FIG. 1.

FIG. 4 is a diagram showing an example of neighboring pixels in the image display device shown in FIG. 1.

FIG. 5 is a flowchart showing processing performed on a selected pixel in the image display device according to the first embodiment.

FIG. 6 is a flowchart showing a detail of step S105 shown in FIG. 5.

FIG. 7 is a diagram showing a method for calculating integrated brightness in a case where a line of sight moves in the right direction.

FIG. 8 is a diagram showing a method for calculating integrated brightness in a case where the line of sight moves in the left direction.

FIG. 9 is a diagram showing integrated brightness calculated by the image display device according to the first embodiment.

FIG. 10 is a diagram showing brightness of each subframe in the image display device according to the first embodiment.

FIG. 11 is a diagram showing final integrated brightness calculated in the image display device according to the first embodiment.

FIG. 12 is a flowchart showing processing performed on a selected pixel in an image display device according to a second embodiment of the present invention.

FIG. 13 is a diagram showing an example of coefficients in the image display device according to the second embodiment.

FIG. 14 is a diagram showing a state where a green display area and a white display area are adjacent to each other.

FIG. 15 is a diagram showing brightness of each subframe and integrated brightness in the image display device according to the second embodiment.

FIG. 16 is a flowchart showing processing performed on a selected pixel in an image display device according to a modified example of the second embodiment.

FIG. 17 is a flowchart showing processing performed on a selected pixel in an image display device according to a third embodiment of the present invention.

FIG. 18 is a diagram showing a distribution ratio determining method in an image display device according to a fourth embodiment of the present invention.

FIG. 19 is a diagram showing brightness of pixels of each subframe in the image display device according to the fourth embodiment.

FIG. 20 is a diagram showing a state where two pixels are adjacent to each other.

FIG. 21 is a diagram showing brightness of each subframe in a conventional image display device.

FIG. 22 is a diagram showing integrated brightness in the conventional image display device.

### MODES FOR CARRYING OUT THE INVENTION

### First Embodiment

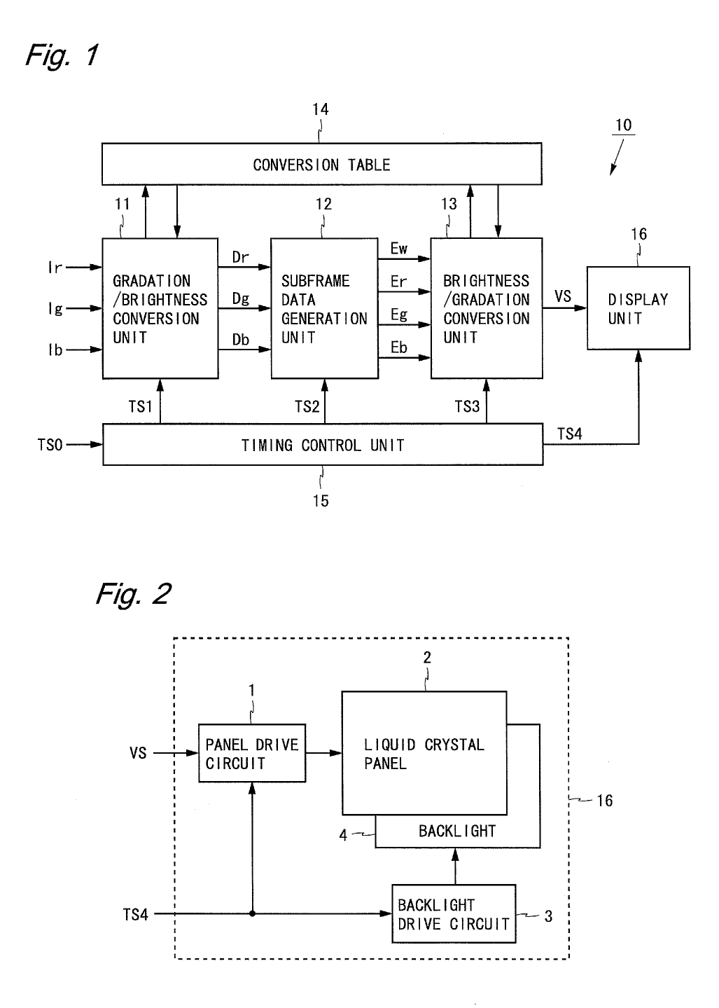

FIG. 1 is a block diagram showing a configuration of an image display device according to a first embodiment of the present invention. An image display device 10 shown in FIG. 1 includes a gradation/brightness conversion unit 11, a subframe data generation unit 12, a brightness/gradation conversion unit 13, a conversion table 14, a timing control unit 15, and a display unit 16. The image display device 10 is a field-sequential image display device for displaying four subframes (white, red, green, and blue subframes) in one frame period. In the image display device 10, one frame period is divided into four subframe periods (white, red, green, and blue subframe periods).

As illustrated in FIG. 1, input gradation data corresponding to color components of three colors is input from the outside into the image display device 10. The input gradation data includes red gradation data Ir, green gradation data Ig, and blue gradation data Ib. The input gradation data represents gradation of each pixel.

The gradation/brightness conversion unit 11 performs inverse-gamma conversion to convert the input gradation data to input brightness data. The input brightness data represents brightness of each pixel. The gradation/brightness conversion unit 11 converts the red gradation data Ir, the green gradation data Ig, and the blue gradation data Ib respectively to red brightness data Dr, green brightness data Dg, and blue brightness data Db. Hereinafter, it is assumed that the brightness represented by each of the red brightness data Dr, the green brightness data Dg, and the blue brightness data Db is regulated with the maximum brightness being 1.

The subframe data generation unit 12 generates output brightness data corresponding to the subframes of four colors based on the input brightness data corresponding to the three color components. The output brightness data represents brightness of each pixel. The subframe data generation unit 12 generates brightness data Ew, Er, Eg, Eb of four colors based on the brightness data Dr, Dg, Db of three colors.

The brightness/gradation conversion unit 13 performs gamma conversion to convert the output brightness data to output gradation data. The output gradation data represents gradation of each pixel. The brightness/gradation conversion unit 13 converts the brightness data Ew, Er, Eg, Eb of four colors respectively to display gradation data of four colors (display gradation data of white, red, green, and blue), and outputs a video signal VS containing the display gradation data of four colors.

The conversion table 14 stores data required for inverse-gamma conversion in the gradation/brightness conversion unit 11 and for gamma conversion in the brightness/gradation conversion unit 13. Based on a timing control signal ISO supplied from the outside of the image display device 10, the timing control unit 15 outputs timing control signals TS1 to TS4 respectively to the gradation/brightness conversion unit 11, the subframe data generation unit 12, the brightness/gradation conversion unit 13, and the display unit 16. The display unit 16 performs field-sequential drive based on the video signal VS and the timing control signal TS4 to display four subframes in one frame period.

FIG. 2 is a block diagram showing a configuration of the display unit 16. The display unit 16 shown in FIG. 2 includes a panel drive circuit 1, a liquid crystal panel 2, a backlight drive circuit 3, and a backlight 4. The liquid crystal panel 2 includes a plurality of pixels arranged two-dimensionally (not shown). The panel drive circuit 1 drives the liquid crystal panel 2 based on the video signal VS and the timing control signal TS4. The panel drive circuit 1 drives the liquid crystal panel 2 based on the display gradation data of white, red, green, and blue in the white, red, green, and blue subframe periods, respectively.

The backlight 4 includes a red light source, a green light source, and a blue light source (none of which is shown). For the light source of the backlight 4, an LED (Light Emitting Diode) is used, for example. In each subframe period, the backlight drive circuit 3 causes the light source to emit light in accordance with the color of the subframe based on the timing control signal TS4. Specifically, the backlight drive circuit 3 causes the red light source to emit light in the red subframe period, causes the green light source to emit light in the green subframe period, causes the blue light source to emit light in the blue subframe period, and causes the red light source, the green light source, and the blue light source to emit light in the white subframe period. Thereby, the white, red, green, and blue subframes are displayed on the liquid crystal panel 2 sequentially in one frame period. Note that the configuration of the display unit 16 is not limited to the configuration shown in FIG. 2.

In the image display device 10, brightness of each pixel contained in the white brightness data Ew (hereinafter referred to as the brightness of the white subframe) can be determined within a range from 0 to the minimum value of the brightness of red, green, and blue. Increasing the brightness of the white subframe can suppress the color breakup, but increases the tendency of the irregular flicker to occur in the vicinity of the boundary of the pixels. On the contrary, lowering the brightness of the white subframe can suppress the irregular flicker, but increases the tendency of the color breakup to occur. To suppress the color breakup and the irregular flicker suitably, the subframe data generation unit 12 determines the brightness of the white subframe by a method shown below. Hereinafter, a ratio of the brightness of the white subframe with respect to the maximum value that can be taken by the brightness of the white subframe is referred to as a “distribution ratio α”.

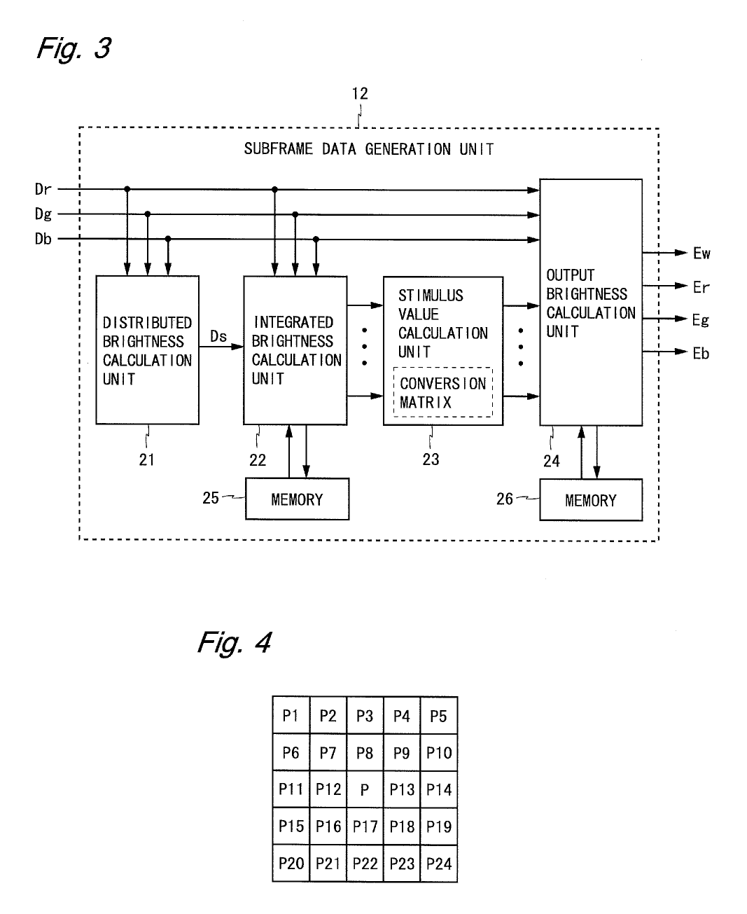

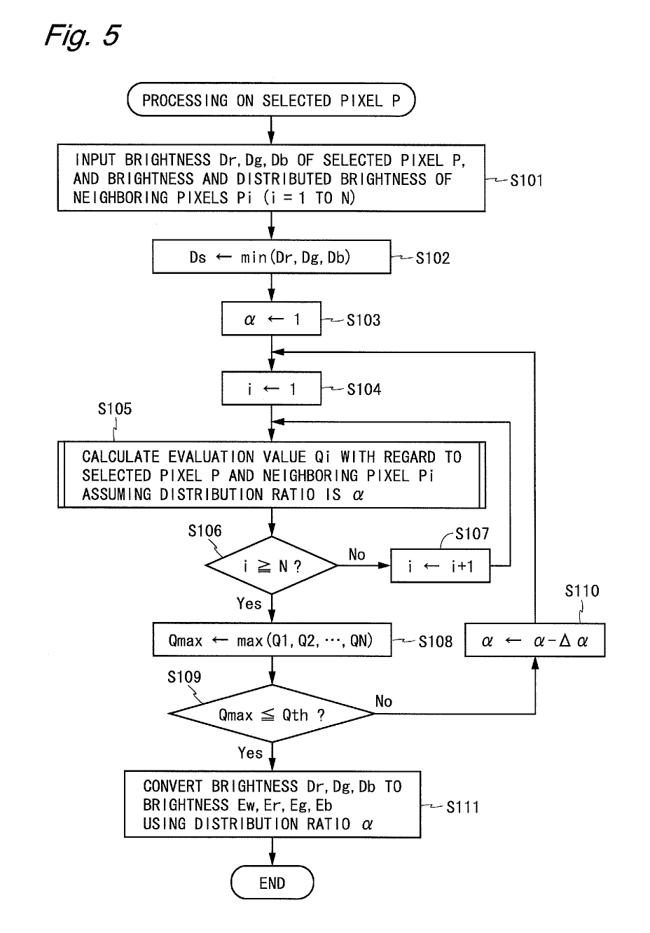

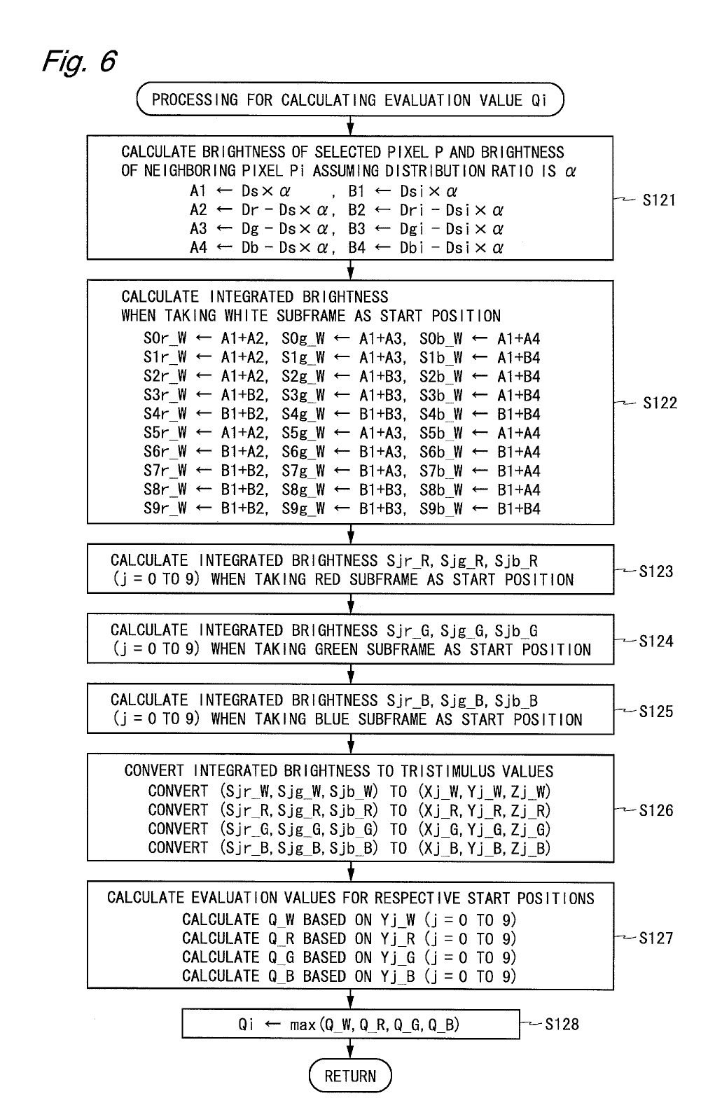

FIG. 3 is a block diagram showing a detailed configuration of the subframe data generation unit 12. As shown in FIG. 3, the subframe data generation unit 12 includes a distributed brightness calculation unit 21, an integrated brightness calculation unit 22, a stimulus value calculation unit 23, an output brightness calculation unit 24, and memories 25, 26. The subframe data generation unit 12 selects pixels sequentially and performs processing shown in FIGS. 5 and 6 on the pixel which is selected. Hereinafter, the pixel which is selected is referred to as a selected pixel, and pixels close to the selected pixel are referred to as neighboring pixels. The subframe data generation unit 12 generates the output brightness data with regard to each selected pixel based on the input brightness data by determining the distribution ratio α for each pixel based on brightness of the selected pixel and brightness of the neighboring pixels, and distributing the brightness of the selected pixel to a plurality of subframes in accordance with the calculated distribution ratio α. In the following example, as shown in FIG. 4, 24 pixels P1 to P24, located within a range of two pixels arranged horizontally from a selected pixel P and two pixels arranged vertically from the selected pixel P, are taken as neighboring pixels.

The memory 25 is a working memory of the integrated brightness calculation unit 22, and the memory 26 is a working memory of the output brightness calculation unit 24. Based on the input brightness data, the distributed brightness calculation unit 21 calculates distributed brightness data Ds representing brightness to be distributed to a plurality of subframes (hereinafter referred to as distributed brightness). More specifically, with regard to each pixel, the distributed brightness calculation unit 21 calculates the minimum value of the brightness data Dr, Dg, Db of three colors and outputs the distributed brightness data Ds containing the calculated minimum value.

Based on the input brightness data and the distributed brightness data Ds, the integrated brightness calculation unit 22 calculates integrated brightness when a line of sight moves and integrated brightness when the line of sight is fixed. More specifically, the integrated brightness calculation unit 22 calculates integrated brightness assuming that the distribution ratio is a, based on the brightness data Dr, Dg, Db and the distributed brightness data Ds of three colors of the selected pixel, and the brightness data and the distributed brightness data of three colors of the neighboring pixels which are stored in the memory 25.

The stimulus value calculation unit 23 performs RGB-XYZ conversion to convert the integrated brightness when the line of sight moves and the integrated brightness when the line of sight is fixed, calculated by the integrated brightness calculation unit 22, to tristimulus values. The output brightness calculation unit 24 generates the output brightness data based on the input brightness data and the tristimulus values calculated by the stimulus value calculation unit 23.

FIG. 5 is a flowchart showing processing performed on the selected pixel P by the subframe data generation unit 12. FIG. 6 is a flowchart showing a detail of step S105 (processing for calculating an evaluation value Qi). Hereinafter, the number of neighboring pixels (24, herein) is represented by N, the brightness of three colors of the selected pixel P is represented by Dr, Dg, Dg, the brightness of three colors of the neighboring pixel Pi (i=1 to N) is represented by Dri, Dgi, Dbi, and distributed brightness of the neighboring pixel Pi is represent by Dsi. Of steps shown in FIGS. 5 and 6, step S102 is performed by the distributed brightness calculation unit 21, steps S121 to S125 are performed by the integrated brightness calculation unit 22, step S126 is performed by the stimulus value calculation unit 23, and the other steps are performed by the output brightness calculation unit 24. The subframe data generation unit 12 may perform steps in parallel, which can be performed in parallel, out of the steps shown in FIGS. 5 and 6.

First, the brightness Dr, Dg, Db of the selected pixel P, the brightness Dri, Dgi, Dbi of the N neighboring pixels Pi, and the distributed brightness Dsi of the N neighboring pixels Pi are input to the subframe data generation unit 12 (step S101). Note that the brightness and the distributed brightness of the neighboring pixels Pi are stored in the memory 25 before step S101 is performed. Next, the distributed brightness calculation unit 21 calculates the minimum value of the brightness Dr, Dg, Db as distributed brightness Ds of the selected pixel P (step S102). Next, the output brightness calculation unit 24 sets 1 to the distribution ratio α (step S103). The value of 1 set in step S103 is a value at which the color breakup is the smallest.

Next, the subframe data generation unit 12 performs steps S104 to S110 repeatedly until Yes is determined in step S109. In step S104, the output brightness calculation unit 24 assigns 1 to a variable i. Next, the subframe data generation unit 12 performs the processing shown in FIG. 6, to calculate the evaluation value Qi with regard to the selected pixel P and the neighboring pixel Pi assuming that the distribution ratio is α (step S105). Next, the output brightness calculation unit 24 determines whether or not i is Nor larger (step S106). When No is determined in step S106, the output brightness calculation unit 24 adds 1 to the variable i (step S107) and goes to step S105. When Yes is determined in step S106, the output brightness calculation unit 24 goes to step S108.

In step S108, the output brightness calculation unit 24 calculates the maximum value Qmax of the N evaluation values Qi. Next, the output brightness calculation unit 24 determines whether or not the maximum value Qmax of the evaluation values is less than or equal to a threshold Qth which is determined in advance (step S109). When No is determined in step S109, the output brightness calculation unit 24 subtracts a predetermined value Δα (>0) from the distribution ratio α (step S110) and goes to step S104. When Yes is determined in step S109, the output brightness calculation unit 24 goes to step S111.

The distribution ratio α of the selected pixel P is determined by the processing before step S111. The output brightness calculation unit 24 converts the brightness Dr, Dg, Db of three colors of the selected pixel P to brightness Ew, Er, Eg, Eb of four colors using the determined distribution ratio α (step S111). Specifically, the output brightness calculation unit 24 performs the following calculation.

Ew=Ds×α

Er=Dr−Ds×α

Eg=Dg−Ds×α

Eb=Eb−Ds×α

In FIG. 6, the integrated brightness calculation unit 22 calculates the brightness of the selected pixel P and the brightness of the neighboring pixel Pi assuming that the distribution ratio is a (step S121). Specifically, the integrated brightness calculation unit 22 performs the following calculation.

A1=Ds×α,B1=Dsi×α

A2=Dr−Ds×α,B2=Dri−Dsi×α

A3=Dg−Ds×α,B3=Dgi−Dsi×α

A4=Db−Ds×α,B4=Dbi−Dsi×α

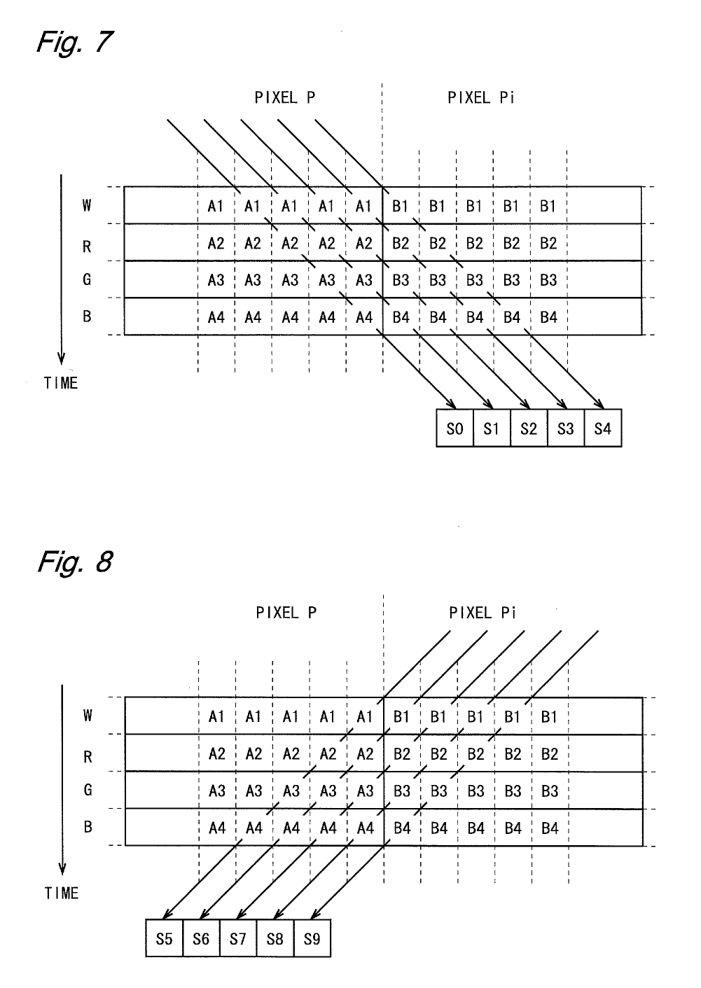

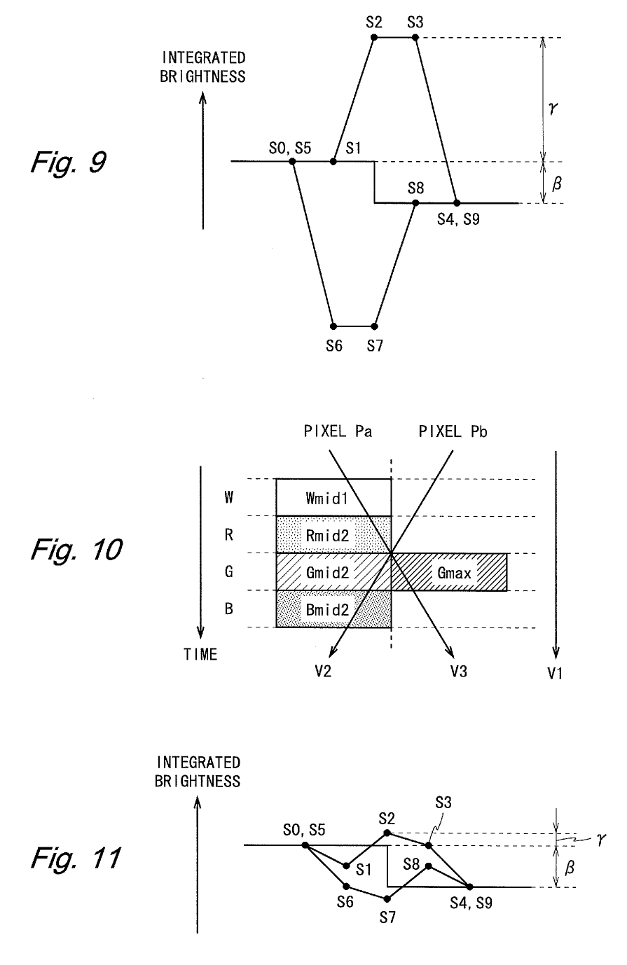

Next, the integrated brightness calculation unit 22 calculates integrated brightness Sjr_W, Sjg_W, Sjb_W (j=0 to 9) when taking the white subframe as a start position (step S122). FIG. 7 is a diagram showing a method for calculating integrated brightness when taking the white subframe as the start position and the line of sight of the observer moves in the right direction. FIG. 8 is a diagram showing a method for calculating integrated brightness when taking the white subframe as the start position and the line of sight of the observer moves in the left direction. The subframe data generation unit 12 adds up the brightness of the subframes in an oblique arrow direction shown in each of FIGS. 7 and 8, to calculate integrated brightness.

For example, the integrated brightness calculation unit 22 performs the following calculation, to calculate integrated brightness at a position S1.

S1r_W=A1+A2,S1g_W=A1+A3,S1b_W=A1+B4

Further, the integrated brightness calculation unit 22 performs the following calculation, to calculate integrated brightness at positions S0 and S2 to S9.

S0r_W=A1+A2,S0g_W=A1+A3,S0b_W=A1+A4,

S2r_W=A1+A2,S2g_W=A1+B3,S2b_W=A1+B4,

S3r_W=A1+B2,S3g_W=A1+B3,S3b_W=A1+B4,

S4r_W=B1+B2,S4g_W=B1+B3,S4b_W=B1+B4,

S5r_W=A1+A2,S5g_W=A1+A3,S5b_W=A1+A4,

S6r_W=B1+A2,S6g_W=B1+A3,S6b_W=B1+A4,

S7r_W=B1+B2,S7g_W=B1+A3,S7b_W=B1+A4,

S8r_W=B1+B2,S8g_W=B1+B3,S8b_W=B1+A4,

S9r_W=B1+B2,S9g_W=B1+B3,S9b_W=B1+B4,

Next, the integrated brightness calculation unit 22 performs the following calculation, to calculate integrated brightness Sjr_R, Sjg_R, Sjb_R (j=0 to 9) when taking the red subframe as the start position (step S123).

S0r_R=A2+A1,S0g_R=A3+A1,S0b_R=A4+A1,

S1r_R=A2+B1,S1g_R=A3+B1,S1b_R=A4+B1,

S2r_R=A2+B1,S2g_R=A3+B1,S2b_R=B4+B1,

S3r_R=A2+B1,S3g_R=B3+B1,S3b_R=B4+B1,

S4r_R=B2+B1,S4g_R=B3+B1,S4b_R=B4+B1,

S5r_R=A2+A1,S5g_R=A3+A1,S5b_R=A4+A1,

S6r_R=B2+A1,S6g_R=A3+A1,S6b_R=A4+A1,

S7r_R=B2+A1,S7g_R=B3+A1,S7b_R=A4+A1,

S8r_R=B2+A1,S8g_R=B3+A1,S8b_R=B4+A1,

S9r_R=B2+B1,S9g_R=B3+B1,S9b_R=B4+B1

Next, the integrated brightness calculation unit 22 performs the following calculation, to calculate integrated brightness Sjr_G, Sjg_G, Sjb_G (j=0 to 9) when taking the green subframe as the start position (step S124).

S0r_G=A1+A2,S0g_G=A3+A1,S0b_G=A4+A1,

S1r_G=A1+B2,S1g_G=A3+A1,S1b_G=A4+A1,

S2r_G=B1+B2,S2g_G=A3+B1,S2b_G=A4+B1,

S3r_G=B1+B2,S3g_G=A3+B1,S3b_G=B4+B1,

S4r_G=B1+B2,S4g_G=B3+B1,S4b_G=B4+B1,

S5r_G=A1+A2,S5g_G=A3+A1,S5b_G=A4+A1,

S6r_G=A1+A2,S6g_G=B3+A1,S6b_G=A4+A1,

S7r_G=A1+A2,S7g_G=B3+A1,S7b_G=B4+A1,

S8r_G=B1+A2,S8g_G=B3+B1,S8b_G=B4+B1,

S9r_G=B1+B2,S9g_G=B3+B1,S9b_G=B4+B1

Next, the integrated brightness calculation unit 22 performs the following calculation, to calculate integrated brightness Sjr_B, Sjg_B, Sjb_B (j=0 to 9) when taking the blue subframe as the start position (step S125).

S0r_B=A1+A2,S0g_B=A1+A3,S0b_B=A4+A1,

S1r_B=A1+A2,S1g B=A1+B3,S1b_B=A4+A1,

S2r_B=A1+B2,S2g_B=A1+B3,S2b_B=A4+A1,

S3r_B=B1+B2,S3g_B=B1+B3,S3b_B=A4+B1,

S4r_B=B1+B2,S4g_B=B1+B3,S4b_B=B4+B1,

S5r_B=A1+A2,S5g_B=A1+A3,S5b_B=A4+A1,

S6r_B=A1+A2,S6g_B=A1+A3,S6b_B=B4+A1,

S7r_B=B1+A2,S7g_B=B1+A3,S7b_B=B4+B1,

S8r_B=B1+B2,S8g_B=B1+A3,S8b_B=B4+B1,

S9r_B=B1+B2,S9g_B=B1+B3,S9b_B=B4+B1

Next, the stimulus value calculation unit 23 converts the integrated brightness calculated in steps S122 to S125 to tristimulus values (step S126). The stimulus value calculation unit 23 includes a conversion matrix for converting brightness of the RGB color system to stimulus values of the XYZ color system. The stimulus value calculation unit 23 performs the RGB-XYZ conversion using the conversion matrix, to convert the integrated brightness (Sjr_W, Sjg_W, Sjb_W) (j=0 to 9) to tristimulus values (Xj_W, Yj_W, Zj_W) (j=0 to 9) when taking the white subframe as the start position. In a similar manner, the stimulus value calculation unit 23 converts the integrated brightness (Sjr_R, Sjg_R, Sjb_R) (j=0 to 9) to tristimulus values (Xj_R, Yj_R, Zj_R) (j=0 to 9) when taking the red subframe as the start position, converts the integrated brightness (Sjr_G, Sjg_G, Sjb_G) (j=0 to 9) to tristimulus values (Xj_G, Yj_G, Zj_G) (j=0 to 9) when taking the green subframe as the start position, and converts the integrated brightness (Sjr_B, Sjg_B, Sjb_B) (j=0 to 9) to tristimulus values (Xj_B, Yj_B, Zj_B) (j=0 to 9) when taking the blue subframe as the start position.

Next, based on the tristimulus values calculated in step S126, the output brightness calculation unit 24 calculates evaluation values Q_W, Q_R, Q_G, Q_B with regard to the respective start positions (step S127). In the present embodiment, the output brightness calculation unit 24 calculates the evaluation values Q_W, Q_R, Q_G, Q_B using a Y value of the tristimulus values.

FIG. 9 is a diagram showing integrated brightness at the positions S0 to S9. In FIG. 9, β represents a variation in the integrated brightness (Y value) when the line of sight is fixed, and γ represents a variation in the integrated brightness (Y value) when the line of sight moves. The variation β in the integrated brightness when the line of sight is fixed is given by |Y0_W−Y9_W|. The variation γ in the integrated brightness when the line of sight moves is given by the maximum value of min (|Yj_W−Y0_W|, |Yj_W−Y9_W|). The output brightness calculation unit 24 calculates the variation β when the line of sight is fixed and the variation γ when the line of sight moves based on ten Y values Y0_W to Y9_W when taking the white subframe as the start position, and defines a ratio γ/β of the variation γ with respect to the variation β as the evaluation value Q_W when taking the white subframe as the start position.

In a similar manner, the output brightness calculation unit 24 calculates the evaluation value Q_R when taking the red subframe as the start position based on ten Y values Y0_R to Y9_R when taking the red subframe as the start position, calculates the evaluation value Q_G when taking the green subframe as the start position based on ten Y values Y0_G to Y9_G when taking the green subframe as the start position, and calculates the evaluation value Q_B when taking the blue subframe as the start position based on ten Y values Y0_B to Y9_B when taking the blue subframe as the start position.

Next, the output brightness calculation unit 24 calculates the maximum value of the four evaluation values Q_W, Q_R, Q_G, Q_B calculated in step S127, and defines the calculated maximum value as the evaluation value Qi assuming that the distribution ratio is α with regard to the selected pixel P and the neighboring pixel Pi (step S128).

Although the stimulus value calculation unit 23 converts the integrated brightness to the tristimulus values in the above description, the stimulus value calculation unit 23 may only calculate a value which is required for calculating the evaluation value (Y value, herein), out of the tristimulus values based on the integrated brightness.

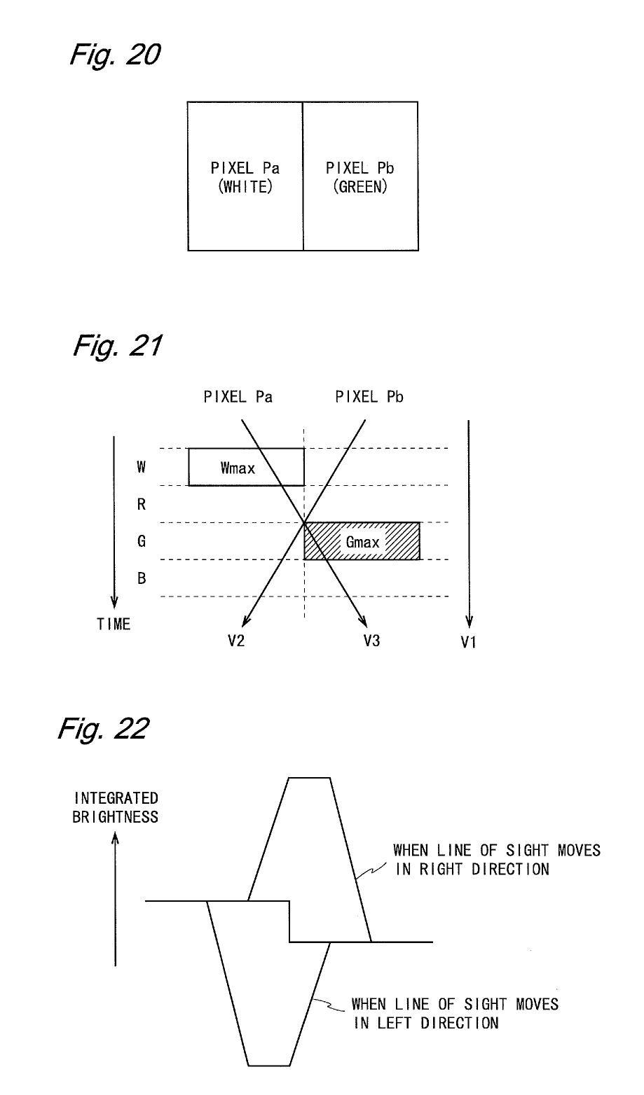

Hereinafter, effects of the image display device 10 according to the present embodiment are described in comparison with the conventional image display device (an image display device which displays white, red, green, and blue subframes in one frame period and defines for each pixel the minimum value of gradation of red, green, and blue as gradation of white). As an example, there is considered a case where a pixel Pa that displays white and a pixel Pb that displays green are adjacent to each other as shown in FIG. 20.

As described with reference to FIGS. 21 and 22, in the conventional image display device, a difference occurs between the integrated brightness when the line of sight moves in the left direction and the integrated brightness when the line of sight moves in the right direction. For this reason, the colors of the pixels Pa, Pb look different to the observer between when the line of sight moves in the left direction and when the line of sight moves in the right direction. As a result, the observer recognizes irregular flicker that occurs in the vicinity of the boundary of the pixels Pa, Pb.

FIG. 10 is a diagram showing brightness of each subframe of the pixels Pa, Pb in the image display device 10. Similarly to the conventional image display device, the brightness of the pixel Pb is the maximum value Gmax in the green subframe, and is zero in the white, red, and blue subframes. Since neighboring pixels of the pixel Pa include pixels that display a different color from the pixel Pa, the distribution ratio α determined by the subframe data generation unit 12 is smaller than the maximum value of 1. Hence in the white subframe, the brightness of the pixel Pa is an intermediate value Wmid1 that is smaller than the maximum value, and in the red, green, and blue subframes, the brightness of the pixel Pa is intermediate values Rmid2, Gmid2, Bmid2 which are larger than zero.

With regard to each pixel, the subframe data generation unit 12 determines the distribution ratio α such that the maximum value Qmax of the evaluation value is less than or equal to the threshold Qth. For this reason, in the image display device 10, the variation γ in the integrated brightness when the line of sight moves is smaller to a predetermined degree (a degree determined using the threshold Qth) as compared with the variation β in the integrated brightness when the line of sight is fixed. As a result, in the image display device 10, the integrated brightness (Y value) at each of the positions S0 to S9 is eventually as shown in FIG. 11, for example. As thus described, by distributing the brightness of the pixel so as to make small the variation yin the integrated brightness when the line of sight moves in consideration of the color difference when the line of sight moves, it is possible to suppress the irregular flicker that occurs in the vicinity of the boundary of the pixels.

Further, the subframe data generation unit 12 determines the distribution ratio α by setting the distribution ratio α to the maximum value at first and decreasing the distribution ratio α in steps until the maximum value Qmax of the evaluation value is less than or equal to the threshold Qth. As thus described, the distribution ratio α is determined to be the maximum value at which the irregular flicker can be suppressed to the predetermined degree. As the distribution ratio α is larger, the color breakup that occurs on the display screen is smaller. Thus, according to the image display device 10, it is possible to suppress the color breakup while suppressing the irregular flicker to the predetermined degree.

Further, in the conventional image display device, when two areas that display different colors are displayed and the display screen is scrolled in a direction orthogonal to the boundary of the areas, the observer may recognize the boundary of the areas as being emphasized. According to the image display device 10 of the present embodiment, it is also possible to suppress unnecessary emphasis that occurs on a boundary of areas when displaying a moving image.

Moreover, when frame interpolation processing is not performed in an image display device in which the number of subframes displayed in one frame period is larger than the number of color components contained in input video data as in the conventional image display device, the observer may recognize judder (a phenomenon of jerky movement of an image) that occurs in the vicinity of the boundary of the areas. According to the image display device 10 of the present embodiment, it is also possible to suppress the judder that occurs in the vicinity of the boundary of the areas.

As shown above, in the image display device 10 according to the present embodiment, the display unit 16 displays each color component of red, green, and blue in accordance with the video signal VS in two subframes in one frame period. The subframe data generation unit 12 generates the output brightness data with regard to each selected pixel P based on the input brightness data by determining the distribution ratio α for each pixel based on the brightness of the selected pixel P and the brightness of the neighboring pixels Pi, and distributing the brightness of the pixel to a plurality of subframes in accordance with the determined distribution ratio α. As thus described, determining the distribution ratio α for each pixel makes it possible to distribute the brightness of the pixel to a plurality of subframes at a suitable ratio, and thus suppress the irregular flicker that occurs in the vicinity of the boundary of the pixels.

With regard to each selected pixel P, the subframe data generation unit 12 calculates the evaluation value Qi related to a color difference when the line of sight moves, based on the brightness of the selected pixel P and the brightness of the neighboring pixels Pi, and determines the distribution ratio α based on the calculated evaluation value Qi. Hence it is possible to distribute the brightness of the pixel at a suitable ratio in consideration of the color difference when the line of sight moves, and thus suppress the irregular flicker.

With regard to each selected pixel P and each neighboring pixel Pi, the subframe data generation unit 12 calculates integrated brightness when the line of sight moves and integrated brightness when the line of sight is fixed, and calculates, as the evaluation value Qi, a ratio of a variation in the integrated brightness when the line of sight moves with respect to a variation in the integrated brightness when the line of sight is fixed, based on the variations in the two kinds of the integrated brightness. Hence it is possible to calculate an evaluation value suitable for suppressing the irregular flicker.

The subframe data generation unit 12 includes the distributed brightness calculation unit 21, the integrated brightness calculation unit 22, and the output brightness calculation unit 24. The output brightness calculation unit 24 generates the output brightness data by calculating the evaluation value Qi based on the integrated brightness when the line of sight moves and the integrated brightness when the line of sight is fixed, determining the distribution ratio α based on the evaluation value Qi, and distributing the brightness of the pixel contained in the input brightness data to a plurality of subframes in accordance with the distribution ratio α. Hence it is possible to constitute the subframe data generation unit 12 of the image display device 10 capable of suppressing the irregular flicker using the distributed brightness calculation unit 21, the integrated brightness calculation unit 22, and the output brightness calculation unit 24. The subframe data generation unit 12 includes the stimulus value calculation unit 23 for converting the integrated brightness when the line of sight moves and the integrated brightness when the line of sight is fixed to stimulus values, and the output brightness calculation unit 24 calculates the evaluation value Qi based on the stimulus values. Hence it is possible to calculate an evaluation value which fits human visual characteristics.

The subframe data generation unit 12 determines the distribution ratio α such that the maximum value of the evaluation value Qi is less than or equal to the threshold Qth with regard to each selected pixel P. Hence it is possible to suppress the irregular flicker to the predetermined degree. Further, with regard to each selected pixel P, the subframe data generation unit 12 determines the distribution ratio α by setting the distribution ratio α to the maximum value of 1 at first, and decreasing the distribution ratio α in steps until the maximum value Qmax of the evaluation value Qi is less than or equal to the threshold Qth. Hence it is possible to suppress the color breakup while suppressing the irregular flicker to the predetermined degree.

The image display device 10 is provided with the gradation/brightness conversion unit 11 and the brightness/gradation conversion unit 13, and the video signal VS is a signal based on output gradation data. Thus, even when input gradation data is input from the outside and the display unit 16 has a nonlinear characteristic, it is possible to constitute the image display device 10 capable of suppressing the irregular flicker using the gradation/brightness conversion unit 11 and the brightness/gradation conversion unit 13.

As for the image display device according to the present embodiment, it is possible to constitute the following modified examples. The subframe data generation unit 12 may perform processing, other than the processing shown in FIGS. 5 and 6, on the selected pixel P. For example, in steps S127 and S128, the output brightness calculation unit 24 may calculate the evaluation value Qi based on a variation in another value representing a color difference when the line of sight moves, in place of the variation in the Y value calculated by the stimulus value calculation unit 23. For example, the output brightness calculation unit 24 may calculate the evaluation value Qi based on an X value or a Z value of the tristimulus values, a value representing hue, brightness, or saturation, a value obtained by weighting and adding these values, or some other value. The value used for calculating the evaluation value Qi and coefficients of the weighted addition are preferably determined in accordance with an evaluation result of the display image.

Further, in place of the loop processing shown in FIG. 5 (steps S104 to S110), the subframe data generation unit 12 may determine the distribution ratio α immediately based on the evaluation value Qi assuming that the distribution ratio α is a certain value (hereinafter referred to as ρ). For example, the subframe data generation unit 12 may perform calculation shown in the following equation (1) based on N evaluation values Qi, to determine the distribution ratio α.

α=ρ×Qth/max(Q1,Q2, . . . ,QN) (1)

However, when a calculated in the equation (1) is larger than or equal to 1, α=1. According to the equation (1), when the maximum value of the evaluation value Qi is larger than the threshold Qth, the distribution ratio α is smaller than ρ (a temporary distribution ratio that is set when calculating the distribution ratio).

The subframe data generation unit 12 may determine the distribution ratio α using another calculation formula that makes the distribution ratio α smaller as the evaluation value Qi is larger. For example, the subframe data generation unit 12 may perform calculation shown in the following equation (2) to determine the distribution ratio α.

α=T/{(Q1+Q2+ . . . +QN)/N} (2)

Further, the subframe data generation unit 12 may perform calculation not including the threshold T, to determine the distribution ratio α. Moreover, based on the brightness data Dr, Dg, Db of three colors, the distributed brightness calculation unit 21 may calculate a value other than the minimum value of the brightness data Dr, Dg, Db (e.g., a value smaller than the minimum value by a predetermined amount) as the distributed brightness data Ds.

### Second Embodiment

An image display device according to a second embodiment of the present invention has the same configuration as that of the image display device according to the first embodiment. The image display device according to the present embodiment is characterized in that with regard to each pixel and each neighboring pixel, the subframe data generation unit 12 makes the evaluation value larger as the distance between the pixel and the neighboring pixel is smaller.

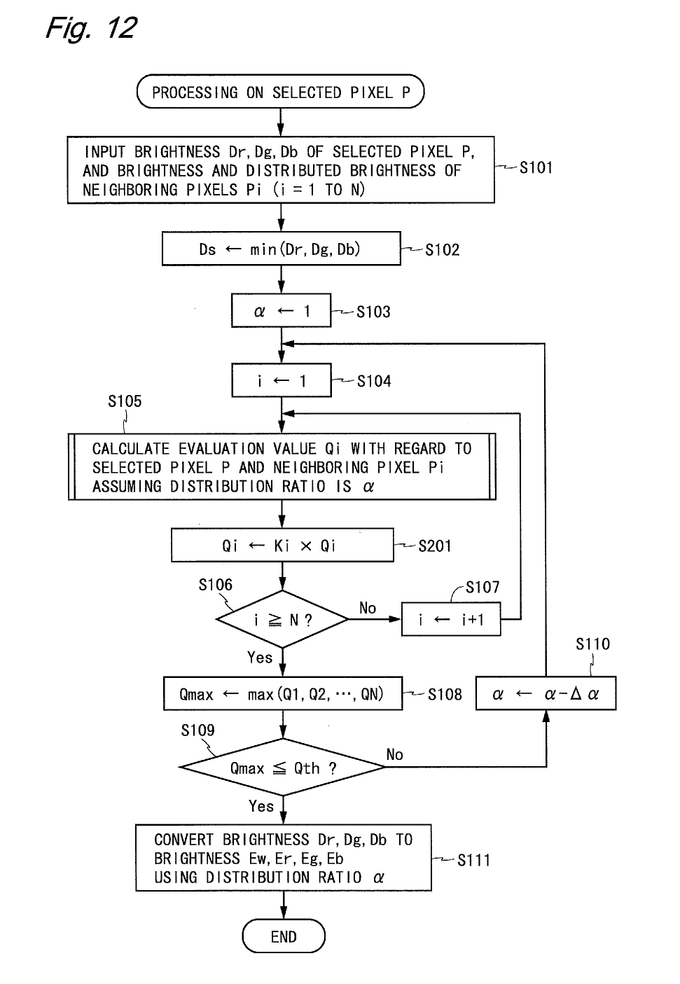

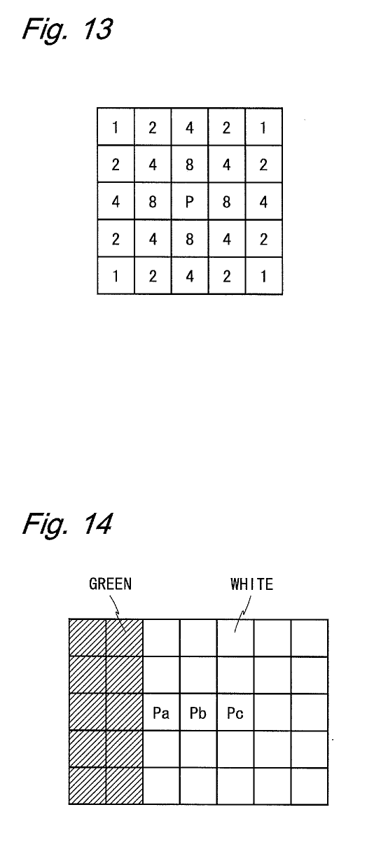

FIG. 12 is a flowchart showing processing performed on the selected pixel P by the subframe data generation unit 12 according to the present embodiment. The flowchart shown in FIG. 12 is obtained by adding step S201 after step S105 in the flowchart shown in FIG. 5. Step S201 is performed by the output brightness calculation unit 24. In step S201, the output brightness calculation unit 24 multiplies the evaluation value Qi calculated in step S105 by a coefficient Ki. The coefficient Ki is set to a larger value as the distance between the selected pixel P and the neighboring pixel Pi is smaller. FIG. 13 is a diagram showing an example of the coefficients Ki. In the example shown in FIG. 13, when Manhattan distances between the selected pixel P and the neighboring pixels Pi are 1 to 4 pixels, the coefficients Ki are 8, 4, 2, and 1, respectively.

The image display device according to the first embodiment performs the same calculation to all of the neighboring pixels when determining the distribution ratio α. For this reason, when areas that display different colors are adjacent to each other, the distribution ratio α may change greatly between pixels in the neighborhood of the boundary of the areas, thus causing deterioration in image quality of the display image. As an example, there is considered a case where a green display area and a white display area are adjacent to each other as shown in FIG. 14. In FIG. 14, a square represents a pixel.

In the image display device according to the first embodiment, neighboring pixels of a pixel Pa include pixels that display green and pixels that display white. Thus, to suppress the irregular flicker, the distribution ratio α of the pixel Pa is determined to be a value smaller than 1. This also applies to a pixel Pb. In contrast, since neighboring pixels of a pixel Pc only include pixels that display white, it is determined that no irregular flicker will occur and the distribution ratio α of the pixel Pc is determined to be 1. When the difference in the distribution ratio α between the pixel Pb and the pixel Pc is large, the image quality of the display image may deteriorate.

In the image display device according to the present embodiment, since the evaluation value Qi is multiplied by the coefficient Ki in step S201, the maximum value of the evaluation value Qi for the pixel Pb is smaller than the maximum value of the evaluation value Qi for the pixel Pa. Hence the distribution ratio of the pixel Pb is larger than the distribution ratio of the pixel Pa, and the distribution ratio α changes smoothly among the pixels Pa, Pb, Pc. Thus, according to the image display device of the present embodiment, it is possible to change the distribution ratio α spatially smoothly, and thus improve the image quality of the display image.

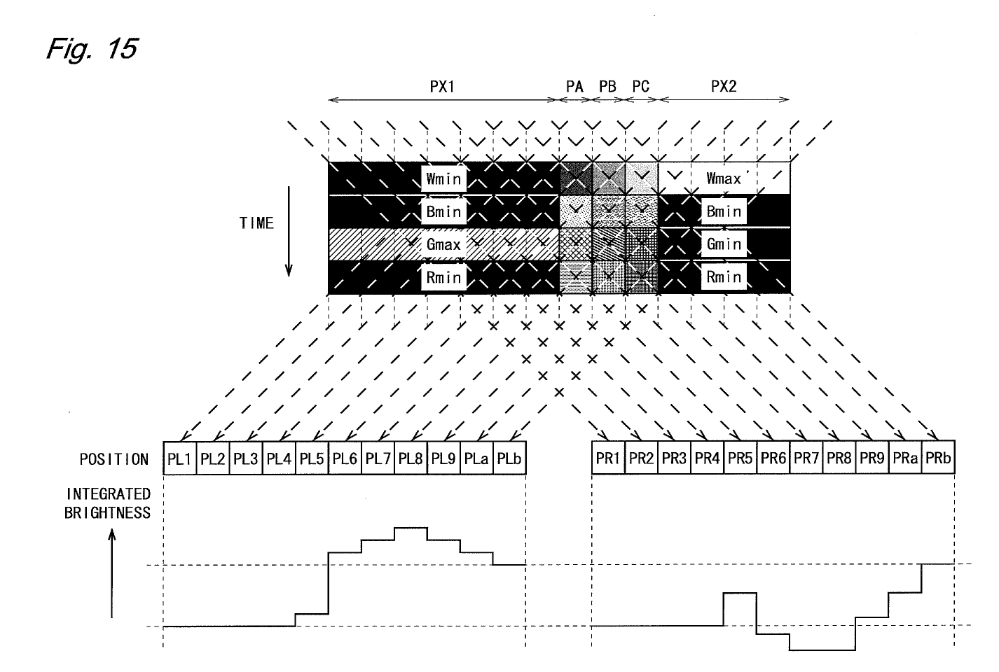

FIG. 15 is a diagram showing brightness of each subframe and integrated brightness in the image display device according to the present embodiment. Similarly to FIG. 14, there is considered a case where a green display area and a white display area are adjacent to each other. However, it is assumed that the image display device displays four subframes in order of white, blue, green, and red in one frame period.

In FIG. 15, brightness of pixels within a range PX1 is the maximum value Gmax in the green subframe, and it is zero (denoted by Wmin, Bmin, Rmin in FIG. 15) in the white, blue, and red subframes, respectively. In the pixel within the range PX2, the distribution ratio α is the maximum value of 1. The brightness of the pixel within the range PX2 is the maximum value Wmax in the white subframe, and it is zero in the red, green, and blue subframes. The distribution ratio α changes smoothly among pixels PA, PB, PC, and a pixel right adjacent to the pixel PC. Specifically, the distribution ratio α increases sequentially in the order of the pixel PA, the pixel PB, the pixel PC, and the pixel right adjacent to the pixel PC.

Only the green component is contained in integrated brightness at positions PL1 to PL4, PR1 to PR4. Only the white component is contained in brightness components at positions PLb, PRb. Since the distribution ratio α changes smoothly among the pixels PA, PB, PC, and the pixel right adjacent to the pixel PC, the brightness component at each of the positions PL5 to PLa changes smoothly. This also applies to the integrated brightness at each of the positions PR5 to PRa. Therefore, both when the line of sight moves in the left direction and when the line of sight moves in the right direction, the brightness of the pixel changes smoothly between the green display area and the white display area. As thus described, according to the image display device of the present embodiment, it is possible to change the distribution ratio α spatially smoothly, and thus improve the image quality of the display image.

As for the image display device according to the present embodiment, it is possible to constitute the following modified examples. The coefficient Ki may be determined arbitrarily as long as it satisfies the condition that the coefficient Ki is larger as the distance between the selected pixel P and the neighboring pixel Pi is smaller. Further, in place of the loop processing shown in FIG. 12 (steps S104 to S110), the subframe data generation unit 12 may determine the distribution ratio α immediately based on the evaluation value Qi assuming that the distribution ratio α is a certain value. For example, the subframe data generation unit 12 may perform calculation shown in the following equation (3) based on N evaluation values Qi, to determine the distribution ratio α.

α=T/max(K1×Q1,K2×Q2, . . . ,KN×QN) (3)

In the equation (3), T represents a threshold which is determined in advance. Further, when max(K1×Q1,K2×Q2, . . . , KN×QN)≦Qth, α=1.

The subframe data generation unit 12 may determine the distribution ratio α using another calculation formula that makes the distribution ratio α smaller as the evaluation value Qi is larger. For example, the subframe data generation unit 12 may perform calculation shown in the following equation (4), to determine the distribution ratio α.

α=T/{(K1×Q1+K2×Q2+ . . . +KN×QN)/N} (4)

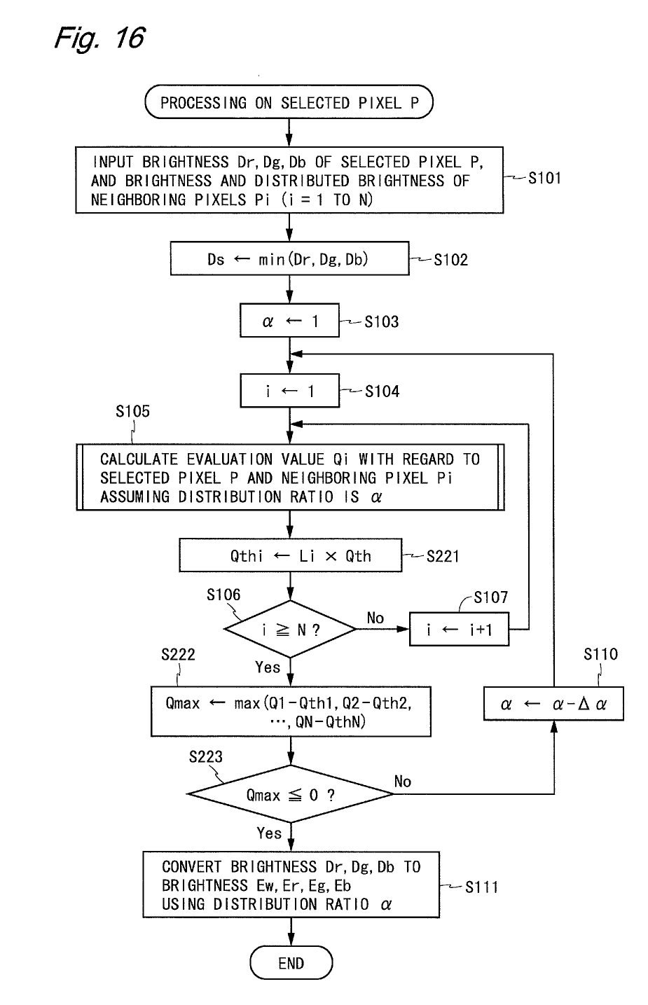

Further, instead of performing the processing of making the evaluation value Qi larger as the distance between the selected pixel P and the neighboring pixel Pi is smaller, the subframe data generation unit 12 may perform processing of making the threshold to be compared with the evaluation value Qi smaller as the distance between the selected pixel P and the neighboring pixel Pi is smaller. FIG. 16 is a flowchart showing processing performed on the selected pixel P by the subframe data generation unit 12 according to the present modified example. The flowchart shown in FIG. 16 is obtained by replacing steps S201, S108, and S109 respectively with steps S221, S222, and S223 in the flowchart shown in FIG. 12.

In step S221, the output brightness calculation unit 24 multiplies the threshold Qth by the coefficient Li, to calculate a threshold Qthi in accordance with the distance between the selected pixel P and the neighboring pixel Pi. The coefficient Li is set to a smaller value as the distance between the selected pixel P and the neighboring pixel Pi is smaller. In step S222, the output brightness calculation unit 24 calculates the maximum value Qmax of N values (Qi−Qthi). In step S223, the output brightness calculation unit 24 determines whether or not the maximum value Qmax calculated in step S222 is 0 or smaller. When No is determined in step S223, the output brightness calculation unit 24 goes to step S110, and when Yes is determined in step S223, the output brightness calculation unit 24 goes to step S111.

As thus described, the threshold Qthi to be compared with the evaluation value Qi is made smaller for the closer neighboring pixel, to have a larger effect on determination of the distribution ratio α, whereby it is possible to change the distribution ratio α spatially smoothly, and thus improve the image quality of the display image.

### Third Embodiment

An image display device according to a third embodiment of the present invention has the same configuration as that of the image display device according to the first embodiment. The image display device according to the present embodiment is characterized in that with regard to each pixel, the subframe data generation unit 12 smooths the distribution ratio α determined based on the evaluation value, in a time axial direction, and distributes the brightness of the pixel to a plurality of subframes in accordance with the smoothed distribution ratio α.

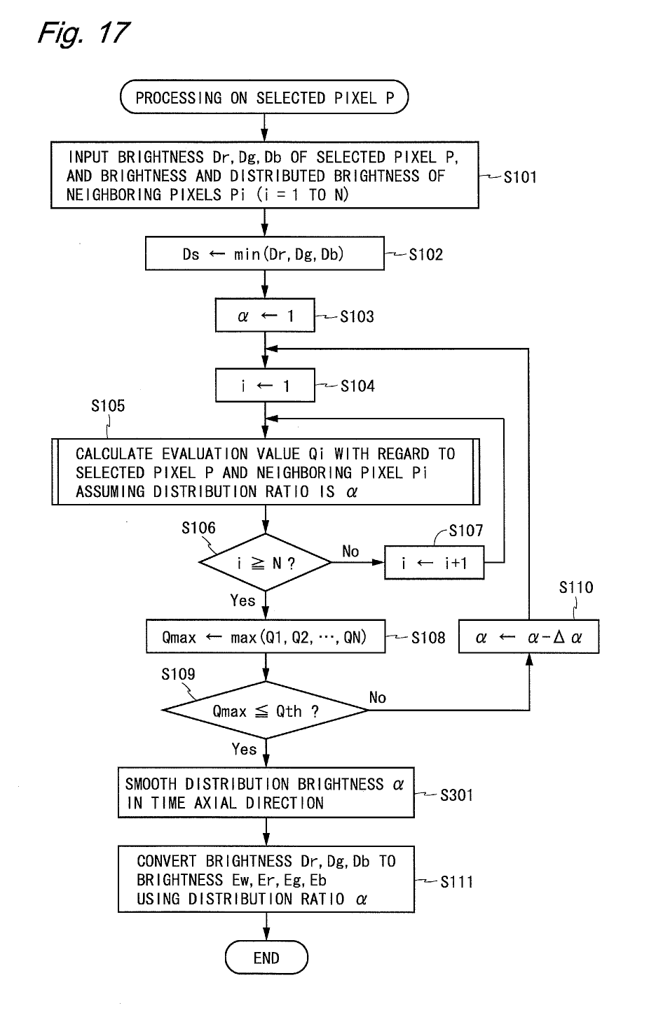

FIG. 17 is a flowchart showing processing performed on the selected pixel P by the subframe data generation unit 12 according to the present embodiment. The flowchart shown in FIG. 17 is obtained by adding step S301 before step S111 in the flowchart shown in FIG. 5. Step S301 is performed by the output brightness calculation unit 24. In step S301, the output brightness calculation unit 24 smooths the distribution ratio α calculated in the processing before step S301, in the time axial direction. Before step S301 is performed, the distribution ratio α determined with regard to the past frame is stored in the memory 26.

The output brightness calculation unit 24 may perform arbitrary smoothing processing in the time axial direction in step S301. For example, the output brightness calculation unit 24 may calculate a simple average or a weighted average of a distribution ratio of the current frame and a distribution ratio of the previous frame. Alternatively, the output brightness calculation unit 24 may calculate a simple average or a weighted average of the distribution ratio of the current frame and distribution ratios of a plurality of past frames. When the weighted average is calculated, a coefficient is preferably made larger for a frame closer to the current frame.

In an image display device in which step S301 is not performed, when a gradation difference is large between the previous frame and the current frame (e.g. in the case of a moving image), the distribution ratio α may change largely between the previous frame and the current frame to cause deterioration in image quality of the display image.

In the image display device according to the present embodiment, the subframe data generation unit 12 smooths the distribution ratio α determined based on the evaluation value, in the time axial direction. Thus, according to the image display device of the present embodiment, it is possible to change the distribution ratio α temporally smoothly, and thus improve the image quality of the display image.

### Fourth Embodiment

An image display device according to a fourth embodiment of the present invention has the same configuration as that of the image display device according to the first embodiment. The image display device according to the present embodiment is characterized in that the subframe data generation unit 12 has a plurality of methods for determining the distribution ratio α, and switches the method for determining the distribution ratio α in units of a pixel.

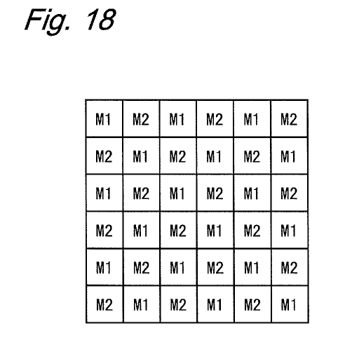

FIG. 18 is a diagram showing a distribution ratio determining method in an image display device according to the present embodiment. In FIG. 18, a square represents a pixel, and a character in the square represents a determination method for a distribution ratio to be applied to the pixel. In FIG. 18, the pixels are classified into two groups in a checkerboard pattern, and a first determination method (denoted by M1) is applied to pixels in a first group while a second determination method (denoted by M2) is applied to pixels in a second group.

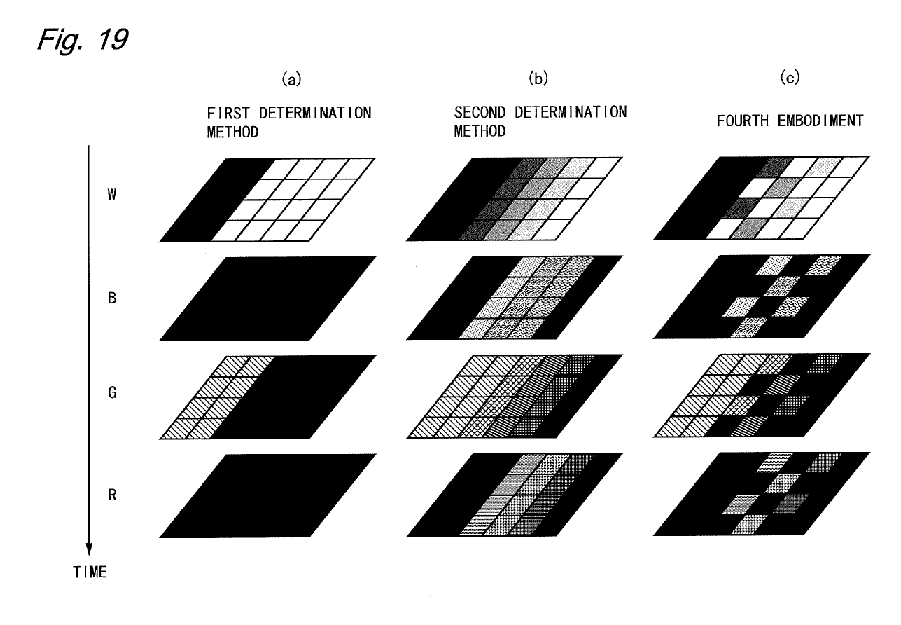

FIG. 19 is a diagram showing brightness of pixels of each subframe in the image display device according to the present embodiment. In FIG. 19, it is assumed that eight pixels on the left side display green, and sixteen pixels on the right side display white. Here, the method of taking the minimum value of gradation of red, green, and blue as gradation of white for each pixel (the method of fixing the distribution ratio α to 1) is applied as a first determination method to the pixels in the first group, and the distribution ratio determining method according to the second embodiment is applied as a second determination method to the pixels in the second group.

If the first determination method is applied to all the pixels, the brightness of the pixels of each subframe is as shown in FIG. 19(a). Further, if the second determination method is applied to all the pixels, the brightness of the pixels of each subframe is as shown in FIG. 19(b). In the image display device according to the present embodiment, the first determination method is applied to the pixels in the first group, and the second determination method is applied to the pixels in the second group. Hence in the image display device according to the present embodiment, the brightness of each subframe is as shown in FIG. 19(c).

In the image display device according to each of the first to third embodiments, even when the distribution ratio determining method according to each embodiment is applied, it is not possible to suppress the color breakup and the irregular flicker completely. Therefore, in the image display device according to the present embodiment, the subframe data generation unit 12 has a plurality of methods for determining the distribution ratio α, and switches the method for determining the distribution ratio α in units of a pixel. It is thereby possible to disperse within the display image the color breakup and the irregular flicker that cannot be suppressed only by applying one distribution ratio determining method, thus enabling improvement in image quality of the display image.

The image display device according to the present embodiment may switch the distribution ratio determining method in units of a pixel in an arbitrary manner. The image display device according to the present embodiment may switch the distribution ratio determining method to three or more kinds. The image display device according to the present embodiment may switch the distribution ratio determining method by the pixel at random, or may switch the method by the row of pixels or by the column of pixels. The image display device according to the present embodiment may classify pixels into a plurality of groups so as to form a specific shape (circular shape, elliptical shape, rhombic shape, and the like) and switch the distribution ratio determining method by the group.

### Modified Examples of Each Embodiment

As for the image display devices according to the embodiments of the present invention, it is possible to constitute the following modified examples. The present invention is applicable to various image display devices that each display at least one color component of red, green, and blue in two or more subframes in one frame period. The present invention is also applicable to an image display device that displays at least one color component of red, green, and blue in two subframes in one frame period. The present invention is also applicable to an image display device that displays cyan, red, green, and blue subframes in one frame period, to an image display device that displays magenta, red, green, and blue subframes in one frame period, and to an image display device that displays yellow, red, green, and blue subframes in one frame period. The present invention is also applicable to an image display device that displays at least one color component of red, green, and blue in three or more subframes in one frame period. For example, the present invention is also applicable to an image display device that displays white, red, green, blue, and white subframes in one frame period, and to an image display device that displays white, cyan, magenta, yellow, red, green, and blue subframes in one frame period. In these image display devices, a plurality of distribution ratios may be determined in a manner similar to those of the first to fourth embodiments.

The present invention is also applicable to an image display device that displays at least one of red, green, and blue subframes a plurality of times in one frame period. For example, the present invention is also applicable to an image display device that displays red, green, blue, and red subframes in one frame period, and to an image display device that displays red, green, blue, red, green, and blue subframes in one frame period. The present invention is also applicable to an image display device that does not display red, green, and blue subframes but displays subframes of a mixed color of red, green, and blue. For example, the present invention is also applicable to an image display device that displays cyan, magenta, and yellow subframes in one frame period, and to an image display device that displays subframes of white, a mixed color of red and another color, a mixed color of green and another color, and a mixed color of blue and another color in one period. In these image display devices, the distribution ratio α may be determined with regard to each color component of red, green, and blue.

The present invention is also applicable to an image display device that switches an emission color of a backlight for each area to have a plurality of areas corresponding to different colors in one subframe. The image display device of the present invention may determine a distribution ratio with regard to each color component of red, green, and blue individually. The present invention is also applicable to an image display device that switches and performs a plurality of systems of field-sequential drive. The present invention is also applicable to an image display device in which the number of color components contained in input video data is different from the number of subframes displayed in one frame period.

The display order of subframes and a drive frequency (field rate) in the image display device of the present invention are arbitrary. For example, the present invention is also applicable to an image display device that displays four subframes in order of white, blue, green, and red in one frame period, and to an image display device that displays four subframes in order of red, green, white, and blue in one frame period. The present invention is also applicable to an image display device that displays a plurality of subframes of a specific color (e.g., white) in one frame period.

Other than the liquid crystal display device, the present invention is also applicable to a PDP (Plasma Display Panel), a MEMS (Micro Electro Mechanical Systems) display, and the like. The present invention is also applicable to an image display device that has a sub-pixel corresponding to each color component and drives a backlight in the field-sequential system. The present invention is also applicable to an image display device that controls brightness of a backlight (either brightness of a total plane or brightness of each area) in accordance with input video data and corrects the input video data accordingly. The present invention is also applicable not only to an image display device provided with a display panel and a backlight, but also to a light emission type image display device. The present invention is also applicable to a field-sequential image display device obtained by combining the above systems arbitrarily.

When brightness data is input from the outside, the image display device of the present invention may not be provided with the gradation/brightness conversion unit for performing inverse-gamma conversion. When the display unit has a linear characteristic, the image display device of the present invention may not be provided with the brightness/gradation conversion unit for performing gamma conversion. In place of the distributed brightness calculation unit, the image display device of the present invention may be provided with a distributed gradation calculation unit for calculating distributed gradation data representing gradation to be distributed to a plurality of subframes based on input gradation data. In this case, the gradation/brightness conversion unit may be provided in a post stage of the distributed gradation calculation unit. Input video data for each subframe subjected to frame interpolation for suppressing the color breakup when displaying a moving image may be input to the image display device of the present invention. In this case, the image display device of the present invention may perform processing on video data corresponding to the subframe to be displayed. Input video data subjected to frequency conversion by frame interpolation processing or the like may be input to the image display device of the present invention. Video data with lowered resolution, video data applied with a low-pass filter or the like, or some other data, may be input to the image display device of the present invention in place of raw data (original video data).

Further, the subframe data generation unit may not be provided with the stimulus value calculation unit when it is unnecessary for calculation of the evaluation value. In the image display device of the present invention, the format of video data input to the subframe data generation unit and the format of video data output from the subframe data generation unit may be arbitrary. In the image display device of the present invention, the range of neighboring pixels may be determined arbitrarily. For example, a pixel with a distance from the selected pixel (Euclidean distance or Manhattan distance) less than or equal to a predetermined distance may be used as the neighboring pixel. Alternatively, every pixel within the display image may be used as the neighboring pixel.

### INDUSTRIAL APPLICABILITY

The image display device of the present invention has the characteristic of suppressing irregular flicker that occurs in the vicinity of a boundary of pixels, and is thus usable for display units of various electronic devices, and the like.

### DESCRIPTION OF REFERENCE CHARACTERS

1: PANEL DRIVE CIRCUIT
2: LIQUID CRYSTAL PANEL
3: BACKLIGHT DRIVE CIRCUIT
4: BACKLIGHT
10: IMAGE DISPLAY DEVICE
11: GRADATION/BRIGHTNESS CONVERSION UNIT
12: SUBFRAME DATA GENERATION UNIT
13: BRIGHTNESS/GRADATION CONVERSION UNIT
14: CONVERSION TABLE
15: TIMING CONTROL UNIT
16: DISPLAY UNIT
21: DISTRIBUTED BRIGHTNESS CALCULATION UNIT
22: INTEGRATED BRIGHTNESS CALCULATION UNIT
23: STIMULUS VALUE CALCULATION UNIT
24: OUTPUT BRIGHTNESS CALCULATION UNIT
25, 26: MEMORY

1. A field-sequential image display device comprising:
a subframe data generation unit for generating output brightness data corresponding to a plurality of subframes based on input brightness data corresponding to a plurality of color components; and
a display unit for displaying the plurality of subframes in one frame period in accordance with a video signal based on the output brightness data,
wherein the subframe data generation unit generates the output brightness data with regard to each pixel based on the input brightness data by determining a distribution ratio for each pixel based on brightness of the pixel and brightness of neighboring pixels, and distributing the brightness of the pixel to the plurality of subframes in accordance with the distribution ratio.

2. The image display device according to claim 1, wherein with regard to each pixel, the subframe data generation unit calculates an evaluation value related to a color difference when a line of sight moves, based on the brightness of the pixel and the brightness of the neighboring pixels, and determines the distribution ratio based on the evaluation value.

3. The image display device according to claim 2, wherein with regard to each pixel and each neighboring pixel, the subframe data generation unit calculates integrated brightness when the line of sight moves and integrated brightness when the line of sight is fixed, and calculates the evaluation value based on variations in the two kinds of integrated brightness.

4. The image display device according to claim 3, wherein with regard to each pixel and each neighboring pixel, the subframe data generation unit calculates, as the evaluation value, a ratio of the variation in the integrated brightness when the line of sight moves with respect to the variation in the integrated brightness when the line of sight is fixed.

5. The image display device according to claim 4, wherein the subframe data generation unit includes
a distributed brightness calculation unit for calculating distributed brightness data representing brightness to be distributed to the plurality of subframes based on the input brightness data,
an integrated brightness calculation unit for calculating the two kinds of integrated brightness based on the input brightness data and the distributed brightness data, and
an output brightness calculation unit for generating the output brightness data by calculating the evaluation value based on the two kinds of integrated brightness, determining the distribution ratio based on the evaluation value, and distributing the brightness of the pixel contained in the input brightness data to the plurality of subframes in accordance with the distribution ratio.

6. The image display device according to claim 5, wherein
the subframe data generation unit further includes a stimulus value calculation unit for converting the two kinds of integrated brightness to stimulus values, and
the output brightness calculation unit calculates the evaluation value based on the stimulus values.

7. The image display device according to claim 2, wherein with regard to each pixel, the subframe data generation unit determines the distribution ratio such that a maximum value of the evaluation values is less than or equal to a threshold.

8. The image display device according to claim 7, wherein the subframe data generation unit determines the distribution ratio with regard to each pixel by setting the distribution ratio to the maximum value at first, and decreasing the distribution ratio in steps until the maximum value of the evaluation value is less than or equal to the threshold.

9. The image display device according to claim 2, wherein with regard to each pixel and each neighboring pixel, the subframe data generation unit makes the evaluation value larger as a distance between the pixel and the neighboring pixel is smaller.

10. The image display device according to claim 2, wherein with regard to each pixel and each neighboring pixel, the subframe data generation unit makes a value to be compared with the evaluation value smaller as a distance between the pixel and the neighboring pixel is smaller.

11. The image display device according to claim 2, wherein with regard to each pixel, the subframe data generation unit smooths the distribution ratio determined based on the evaluation value in a time axial direction, and distributes the brightness of the pixel to the plurality of subframes in accordance with the smoothed distribution ratio.

12. The image display device according to claim 1, wherein the subframe data generation unit has a plurality of methods for determining the distribution ratio, and switches the methods for determining the distribution ratio in units of a pixel.

13. The image display device according to claim 1, further comprising:
a gradation/brightness conversion unit for converting input gradation data to the input brightness data; and
a brightness/gradation conversion unit for converting the output brightness data to output gradation data,
wherein the video signal is based on the output gradation data.

14. A field-sequential image display method comprising:
a step of generating output brightness data corresponding to a plurality of subframes based on input brightness data corresponding to a plurality of color components; and
a step of displaying the plurality of subframes in one frame period in accordance with a video signal based on the output brightness data,
wherein in the step of generating, the output brightness data is generated with regard to each pixel based on the input brightness data by determining a distribution ratio for each pixel based on brightness of the pixel and brightness of neighboring pixels, and distributing the brightness of the pixel to the plurality of subframes in accordance with the distribution ratio.
